(19) United States
(12) Patent Application Publication
(10) Pub. No.: US 2021/0344890 A1
(43) Pub. Date: Nov. 4, 2021

(54) VIDEO DISPLAY APPARATUS AND VIDEO PROCESSING APPARATUS

(71) Applicant: SHARP KABUSHIKI KAISHA, Sakai City, Osaka (JP)

(72) Inventor: HIDEO NAMBA, Sakai City, Osaka (JP)

(21) Appl. No.: 17/273,911

(22) PCT Filed: Sep. 6, 2019
(86) PCT No.: PCT/JP2019/035160

§ 371 Date: Mar. 5, 2021

(30) Foreign Application Priority Data
Sep. 12, 2018 (JP) 2018-170471

(51) Int. Cl. H04N 13/167; H04N 5/247; H04N 13/243; H04N 13/282

(52) U.S. Cl. CPC H04N 13/167; H04N 13/282; H04N 13/243; H04N 5/247

(57) ABSTRACT

In a case that a viewer performs video communication using an ultra high resolution display apparatus with a large screen, a video that can be captured is restricted due to restriction on arrangement of video cameras, and this reduces sense of presence and consequently impairs user experience. Multiple video camera apparatuses arranged outside a display area of a display apparatus are used to generate a video of an arbitrary view point from videos captured by the multiple video camera apparatuses, by using a video processing apparatus on a network and to display the generated video on a display apparatus of a communication partner.

### TECHNICAL FIELD

The present invention relates to a video display apparatus and a video processing apparatus. This application claims priority based on JP 2018-170471 filed on Sep. 12, 2018, the contents of which are incorporated herein by reference.

### BACKGROUND ART

With recent improvement in resolution of display apparatuses, display (image display) apparatuses capable of display in Ultra High Density (UHD) have been introduced. Among such UHD displays, display apparatuses capable of particularly high resolution display are used for 8K super-high vision broadcasting, which is television broadcasting with about 8000 pixels in the lateral direction, and practical utilization of this 8K super-high vision broadcasting has been advanced. For effective performance of such ultra high resolution display, display apparatuses tend to increase in size.

While a network of a wide band is required for transmission of video signals of such ultra high resolution, practical utilization of transmission of video signals of ultra high resolution is in the process of being enabled with the use of optical fiber networks and advanced wireless networks.

Such ultra high resolution display apparatuses are capable of using an abundant amount of information that can be provided to viewers, to thereby be able to provide videos with sense of presence. Video communication using such a video with good immersive feeling is also under study.

### CITATION LIST

### Non Patent Literature

NPL 1: Ministry of Internal Affairs and Communications, “Current State about Advancement of 4K and 8K”, website of the MIC

<https://www.soumu.go.jp/main_content/000276941.pdf>

### SUMMARY OF INVENTION

### Technical Problem

In a case of performing communication using video, sense of presence is increased in a case that a video of a communication partner displayed on a display apparatus is displayed so as to directly face a user performing the communication and to establish eye-to-eye contact between the user and the communication partner. However, a large display apparatus causes significant restriction on video camera apparatuses. This comes from a problem that sense of presence is decreased because the display apparatus does not allow light to pass through, so it is not possible to capture images by a video camera apparatus from behind the display apparatus, and that the video camera apparatus comes, in a case of being disposed on a front face side of the display apparatus, to exist between the user and a video displayed on the display apparatus. This is described using FIG. 2. FIG. 2(a) illustrates an example of an overview of a case where communication using a video is performed. For a user 1-201 performing the video communication, a video of a user 2-203, who is a communication partner, is displayed on a video display apparatus 202. In this case, it is preferable to capture the video of the user 2-203 from a position on the line of sight of the user 1-201 indicated as 208. However, as illustrated in FIG. 2(b), because a video display apparatus 207 used by the user 2-203 does not allow light to completely pass through, it is not possible to capture a video from a location 204 on the corresponding line of sight of the user 1-201 described above. It is possible to capture videos only from locations 205 and 206 that are not blocked by the video display apparatus 207. Capturing a video by placing the video camera apparatus between the video display apparatus 207 and the user 2-203 allows a video to be captured from a location on the corresponding line of sight of the user 1-201. However, in this case, the video camera is in the sight of the user 2-203 viewing the video display apparatus 207, and this harms immersive feeling for the user 2-203. In particular, video camera apparatuses for capturing ultra high resolution videos often use lenses with high resolution, and this causes the video camera apparatuses to increase in size to consequently bring large effects. As a result, the user experience is impaired.

One aspect of the present invention has been made in view of the above problems and discloses an apparatus and a configuration thereof that use multiple video camera apparatuses arranged outside a display area of a display apparatus, use a video processing apparatus in a network to generate a video of an arbitrary view point from videos captured by the multiple video camera apparatuses, and display the generated video on a display apparatus of a communication partner, to thereby enable video communication with good immersive feeling.

### Solution to Problem

(1) In order to achieve the object described above, one aspect of the present invention provides a video display apparatus for communicating with one or more video processing apparatuses, the video display apparatus including: a video display unit; multiple video camera units; a synchronization controller; and a controller, wherein each of the multiple video camera units is installed outside the video display unit, the synchronization controller synchronizes shutters of the multiple video camera units, the controller transmits, to any one of the one or more video processing apparatuses, camera capability information indicating capability of each of the multiple video camera units, camera arrangement information indicating an arrangement condition of the multiple video camera units, display capability information indicating video display capability of the video display unit, and video information obtained through capturing by each of the multiple video camera units, and video information transmitted from any one of the one or more video processing apparatuses is received and the video information is displayed on the video display unit.

(2) In order to achieve the object described above, one aspect of the present invention provides the video display apparatus, wherein the camera arrangement information includes location information of each of the multiple video camera units relative to a prescribed point being used as a reference in the video display unit included in the video display apparatus and includes information on an optical axis of each of the multiple video camera units with respect to a display surface of the video display unit being used as a reference.

(3) In order to achieve the object described above, one aspect of the present invention provides the video display apparatus, wherein the camera capability information includes information on a focal length and a diaphragm of a lens configuration used by each of the multiple video camera units.

(4) In order to achieve the object described above, one aspect of the present invention provides the video display apparatus, wherein the display capability includes at least one of information on a size of the video display unit included in the video display apparatus, information on a possible resolution displayable by the video display unit, information on a possible color depth displayable by the video display apparatus, and information on arrangement of the video display unit.

(5) In order to achieve the object described above, one aspect of the present invention provides the video display apparatus, wherein the controller receives configuration information of each of the video camera units from any one of the one or more video processing apparatuses and configures each of the multiple video camera units in accordance with the configuration information.

(6) In order to achieve the object described above, one aspect of the present invention provides the video display apparatus, wherein in a case that multiple values are configurable in each of at least two of the display capability information, the camera capability information, and the camera arrangement information, combinations of values of the display capability information, the camera capability information, and the camera arrangement information to be transmitted to the video processing apparatus are partially restricted.

(7) In order to achieve the object described above, one aspect of the present invention provides a video processing apparatus for communicating with multiple video display apparatuses including a first video display apparatus and a second video display apparatus, the video processing apparatus including: receiving, from the first video display apparatus, camera capability information indicating capability of multiple video camera units, camera arrangement information indicating an arrangement condition of the multiple video camera units, display capability information indicating video display capability of the video display unit, and video information obtained through capturing by each of the multiple video camera units; generating an arbitrary view point video from the video information thus received; and transmitting the arbitrary video view point video to the second video display apparatus.

(8) In order to achieve the object described above, one aspect of the present invention provides the video processing apparatus, wherein in a case that multiple values are configurable in each of at least two of the display capability information, the camera capability information, and the camera arrangement information, a combination of the display capability information, the camera capability information, and the camera arrangement information is restricted.

### Advantageous Effects of Invention

According to one aspect of the present invention, by transmitting video information obtained through capturing by each of multiple video camera units to a video processing apparatus, receiving video information of video of an arbitrary view point transmitted from the video processing apparatus, and displaying the video information by a video display unit, video communication using video with good immersive feeling is enabled, and this enhances user experience.

### BRIEF DESCRIPTION OF DRAWINGS

FIG. 1 is a diagram illustrating an example of an apparatus configuration of an embodiment of the present invention.

FIG. 2 is a diagram illustrating an example of an arrangement of a video display apparatus and video camera units.

FIG. 3 is a diagram illustrating an example of a configuration of a video display apparatus of an embodiment of the present invention.

FIG. 4 is a diagram illustrating an example of a configuration of the video display apparatus of an embodiment of the present invention.

FIG. 5 is a diagram illustrating an example of a configuration of a light field and a video camera unit of an embodiment of the present invention.

FIG. 6 is a diagram illustrating an example of a configuration of a light field camera of an embodiment of the present invention.

FIG. 7 is a diagram illustrating an example of a configuration during learning of an embodiment of the present invention.

### DESCRIPTION OF EMBODIMENTS

Hereinafter, a radio communication technique according to an embodiment of the present invention will be described in detail with reference to the drawings.

### First Embodiment

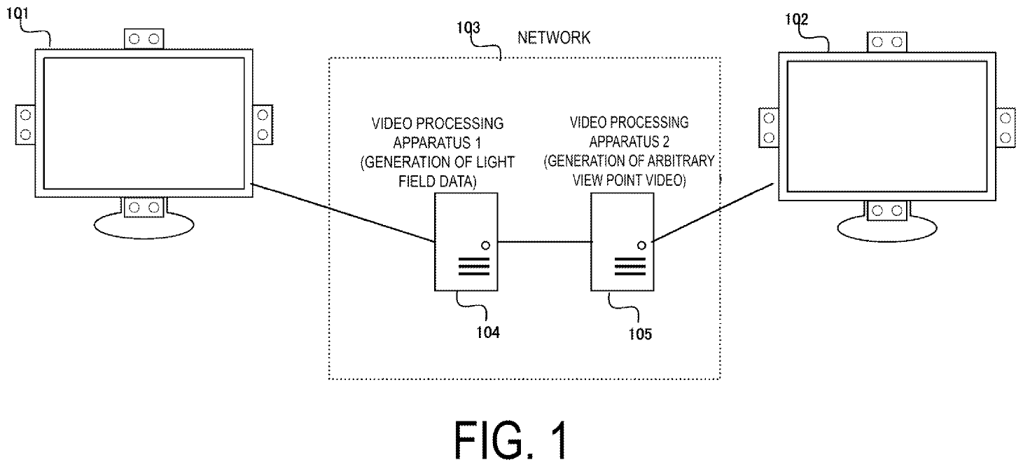

An embodiment of the present invention will be described in detail below using the drawings. FIG. 1 illustrates an example of a configuration of apparatus connection of the present embodiment. Each of 101 and 102 denotes a video display apparatus, and multiple video camera apparatuses are arranged outside a display area. 103 denotes a network and performs communication between the video display apparatus 101 and the video display apparatus 102 as a system. The video display apparatuses 101 and 102 can communicate respectively with a video processing apparatus 1-104 and a video processing apparatus 2-105 via the network 103. The video processing apparatus 1-104 and the video processing apparatus 2-105 may be included directly in the network 103, or may be connected to the network 103 via another network connected to the network 103. The type and shape of the network 103 are not particularly limited and a metal connection such as an Ethernet (trade name), an optical fiber connection, a public wireless network such as a cellular wireless network, a self-owned wireless network via a wireless LAN, or the like may be used for the network 103. The network 103 is only required to have a capacity that can satisfy the information rate of data obtained through capturing and transmitted from each of the video display apparatuses 101 and 102 to the video processing apparatus 1-104 and the information rate of video data transmitted from the video processing apparatus 2-105 to each of the video display apparatuses 101 and 102. The video processing apparatus 1-104 receives display capability information, camera capability information, camera arrangement information, and captured video information from the video display processing apparatus 101 or 102 and generates light field data from these pieces of information. The display capability information, the camera capability information, and the camera arrangement information may be obtained in, instead of a method of directly obtaining such information from the video display apparatus 101 or 102, a method of configuring such information in advance, a method of obtaining connection management information of the video display apparatus 101 or 102 or an identifier capable of identifying the video display apparatus 101 or 102 from another network equipment, for example, equipment configured to perform network connection management, and obtaining, as such information, information associated with the connection management information or the identifier, and the like. The video processing apparatus 2-105 uses the light field data generated by the video processing apparatus 1-104 to generate video data of an arbitrary view point and transmits the video data to the video display apparatus 101 or 102. The view point of video data to be generated may be specified by the video display apparatus 101 or the video display apparatus 102 to receive video information to be generated. Alternatively, the view point of the video data to be generated may be generated by the video processing apparatus 1-104. In this case, either the video processing apparatus 1-104 or the video processing apparatus 2-105 may use the camera capability information, the camera arrangement information, and the captured video information held by the video processing apparatus 1-104, to configure the view point of the video data. Although video processing is shared between the video processing apparatus 1-104 and the video processing apparatus 2-105 in the present embodiment, the video processing may be performed by one video processing apparatus or may be shared among more than two video processing apparatuses. In a case that the video processing is performed by one processing apparatus, the processing apparatus may be divided into blocks therein to share the video processing among the blocks.

The communication between the video display apparatus 101 and the video display apparatus 102 includes a data flow of inputting, to the video processing apparatus 1-104, the display capability information, the camera capability information, and the camera arrangement information from the video display apparatus 101 and video information obtained through capturing by the multiple cameras installed on the video display apparatus 101, using light field data generated by the video processing apparatus 1-104 to generate video data of an arbitrary view point by the video processing apparatus 2-105, and displaying the generated video data of the arbitrary view point in the video display apparatus 102, and a data flow of inputting, to the video processing apparatus 1-104, the display capability information, the camera capability information, and the camera arrangement information from the video display apparatus 102 and video information obtained through capturing by the multiple cameras installed on the video display apparatus 102, using light field data generated by the video processing apparatus 1-104 to generate video data of an arbitrary view point by the video processing apparatus 2-105, and displaying the generated video data of the arbitrary view point by the video display apparatus 101. The two data flows are constituted of equivalent processing. Hence, the following description describes the data flow from the video display apparatus 101 toward the video display apparatus 102, and description of the data flow from the video display apparatus 102 toward the video display apparatus 101 is omitted.

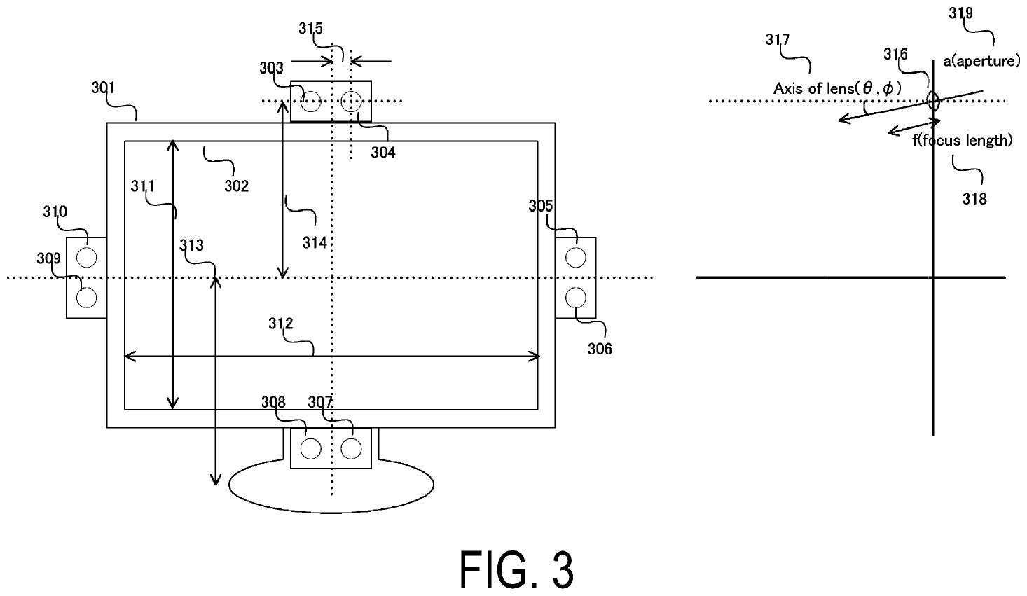

FIG. 3 illustrates a structural overview of the video display apparatuses 101 and 102. Eight video camera units 303 to 310 are arranged on an outside of a cabinet 301 that accommodates a video display unit 302. The display capability information of each of the video display apparatuses 101 and 102 may include information related to the shape of the corresponding one of the video display apparatuses 101 and 102. As an example, the display capability information may include a lateral length 312 and a vertical length 311 of the video display unit which represent the size of the video display unit 302. As information on an installation condition, a distance 313 between a central position of the video display unit 302 and a surface in contact with the video display apparatus 101 or 102 may be included in the display capability information. In the present embodiment, it is assumed that the video display unit 302 arranges a display surface along a vertical direction and arranges a lateral direction of the video display unit in a direction perpendicular to the vertical direction. However, in a case of employing an arrangement method other than this, information on an inclination of the video display unit with respect to the vertical direction and rotation of the video display unit may be included in the display capability information. Information on the resolution of the video display unit, for example, information indicating that display of 3840 pixels in the lateral direction and 2048 pixels in the vertical direction is possible and the like may be included in the display capability information. In a case that the video display unit 302 supports display of multiple resolutions, the possible resolutions for display may be included in the display capability information. As an example, information indicating that all of or any two of resolutions among 7680 by 4320, 3840 by 2160, and 1920 by 1080 (pixels by pixels) are supported or the like may be included in the display capability information. Information on possible color depths for display by the video display unit 302 may also be included in the display capability information. For example, information of 8 bits, 10 bits, or the like as the maximum color depth per pixel may be included in the display capability information. Information on color formats that can be supported, for example, RGB=888, YUV=422, YUV=420, and YUV=444, may also be included in the display capability information.

The camera arrangement information of each of the video display apparatuses 101 and 102 may include an arrangement condition of each of the multiple video camera units 303 to 310 included in the corresponding one of the video display apparatuses 101 and 102. As an example of an arrangement position of the video camera unit 304, which is one of the multiple video camera units 303 to 310, a relative position information of the central position of a front principal point of a lens included in the video camera unit 304 with respect to the central position of the video display unit 302 may be included. Alternatively, a particular point other than the central position may be used as a reference. As this relative position information, a distance 314 in the vertical direction and a distance 315 in the horizontal direction from the central position of the video display unit 302 to the central position of the front principal point of the lens may be used. A relationship from the central position of the video display unit 302 to the central position of the front principal point of the lens may be in a polar coordinate format. The camera arrangement information may also include information on the direction of the optical axis of the lens, and the specification and the configuration of the lens included in each of the video camera units 303 to 310. As an example, an angle (θ, φ) 317 representing the angle of the optical axis of the lens 316 with respect to the vertical direction of a surface of the video display apparatus 302, a focus length f 318 and a diaphragm configuration a 319 of the lens 316, and information F (F value) (not illustrated) on the brightness of the lens 316 may be included in the camera arrangement information. The focus length f 318 and the diaphragm configuration a 319 of the lens 316, and the information F (F value) on the brightness of the lens 316, which indicate the lens configuration may be included in the camera capability information. In the present embodiment, it is assumed that the front principal point of the lens included in each of the video camera units 303 to 310 is arranged on the same plane as that of the video display unit 302. However, no limitation is intended, and the front principal point of the lens need not necessarily be arranged on the same plane as that of the video display unit 302. In a case that each of the video camera units 303 to 310 includes a zoom lens, the position of the front principal point of the lens 316 may be changed as the angle of view for capturing changes. In such a case, information on the position of the front principal point of the lens 316 may be included in camera position information. The information on the position of the front principal point of the lens 316 may use the relative distance of the video display unit 320 from the plane or may be another location information. The positional relationship between the lens 316, the video display unit 302, and the lens 316 may be represented by a value using, as a reference, the position of a flange back or an image sensor, without being limited to the front principal point of the lens 316. The camera capability information may include capability about an imaging element included in each of the video camera units. Examples of such information include information on one of or multiple possible resolutions of a video signal for output by each of the video camera units, possible color depths for output, and a color filter array to be used, information on imaging element array.

The arrangement positions of the video camera units 303 to 310 with respect to the video display unit 302 may be determined in advance. As an example, the arrangement positions may be determined based on the size of the video display unit 302 and the number of video camera units to be used. The size of the elements to be used as the video display unit 302 may be standardized, and positions usable as arrangement positions for the video camera units may be defined based on the size of the elements of the video display units, and arrangement positions to be used may be indicated among the usable positions. One or some of the video camera units 303 to 310 may be configured to be movable to configure multiple usable optical axes, and information on the usable optical axes may be included in the camera capability information.

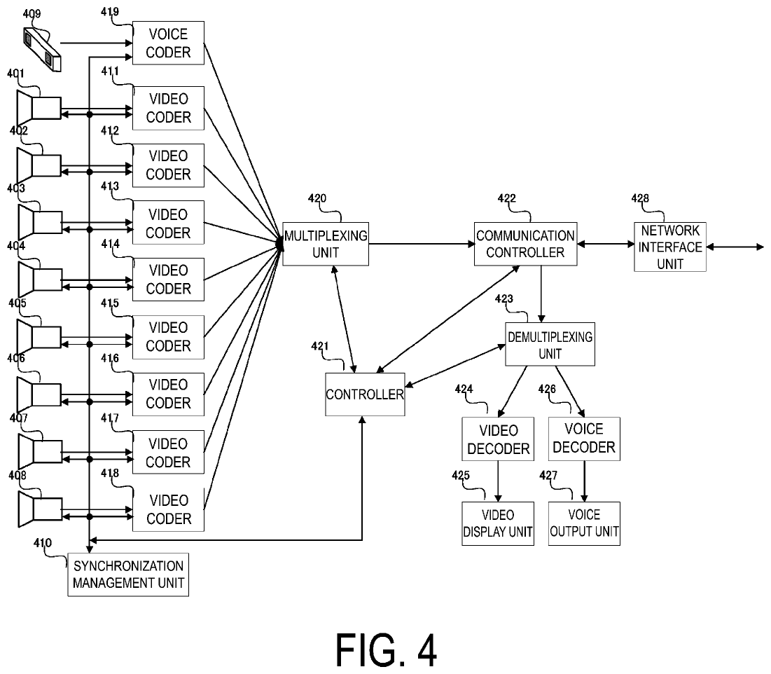

FIG. 4 is a block diagram illustrating an example of a configuration of the video display apparatuses 101 and 102. The video display apparatuses 101 and 102 are assumed to have similar configurations, and hence a description will be given below of the video display apparatus 101. 401 to 408 denote video camera units and correspond to the video camera units 303 to 310 in FIG. 3. 409 denotes a microphone unit including one or more microphone elements. 411 to 418 denote video coders configured to video-code video output signals from the video camera units 401 to 408, respectively, and 419 denotes a voice coder configured to voice-code voice output signal from the microphone unit. 410 synchronizes shutters of the video camera units 401 to 408 and synchronizes the timings of the video coders 411 to 418 in terms of coding unit (such as a Group Of Picture (GOP)) to synchronize the timing of the coding unit (such as a voice frame) the voice coder 419 with the coding unit of video coding. Although it is desirable that the shutters be perfectly synchronized, it is sufficient that the shutters are synchronized to the extent that no contradiction occurs in videos output from the respective video camera units during subsequent signal processing such as coding processing. At this time, in a case that the period of the coding unit of the video coding and the period of the coding unit of the voice coding are different from each other, the voice coding unit may be configured to be timed every prescribed integral multiple of a period other than the periods of these coding units, such as the period of the video coding unit. 420 denotes a multiplexing unit configured to multiplex video-coded data output from the video coders 411 to 418 and voice-coded data output from the voice coder 419. The container format used during this multiplexing is not particularly limited, but an MPEG2-system format, an MPEG Media Transport (MMT) format, a Matroska Video (MKV) format, and the like may be used, for example. 422 denotes a communication controller and is configured to transmit multiplexed data to the video processing apparatus 1-104 for display by the video display apparatus 103, receive, from the video processing apparatus 2-105, video data generated from the data transmitted from the video display apparatus 103 for the display by the video display apparatus 102, and output the video data to a demultiplexing unit 423. 423 is a demultiplexing unit configured to demultiplex the video data output from the communication controller 422 and extract video-coded data and voice-coded data. The video-coded data is output to the video decoder 424, and the voice-coded data is output to the voice decoder 426. In a case that information on the time of the coded data, such as a time stamp, is included in the video data, the coded data to be input to each of the video decoder 424 and the voice decoder 426 may be adjusted so that video and voice after the decoding would be reproduced in accordance with the information on the time. 424 denotes a video decoder configured to decode the input video-coded data and output a video signal, and 425 denotes a video display unit configured to display an input video signal in a human-visible manner and corresponds to 302 in FIG. 3. 426 denotes a voice decoder configured to decode the input voice-coded data and output a voice signal, and 427 denotes a voice output unit configured to amplify the voice signal and convert a resultant signal to voice by using a speaker or the like.

428 denotes an interface unit for connecting the video display apparatus 101 and the network 103 and has a configuration conforming to a scheme used by the network 103. In a case that the network 103 is a wireless network, a wireless modem may be used. In a case that the network 103 uses the Ethernet (trade name), an Ethernet (trade name) adapter may be used. The controller 421 is configured to control all the other blocks and communicate with the video processing apparatus 1-104, the video processing apparatus 2-105, and the video display apparatus 102 via the communication controller 422 to exchange control data with each of the apparatuses. The control data includes display capability information, camera capability information, and camera arrangement information.

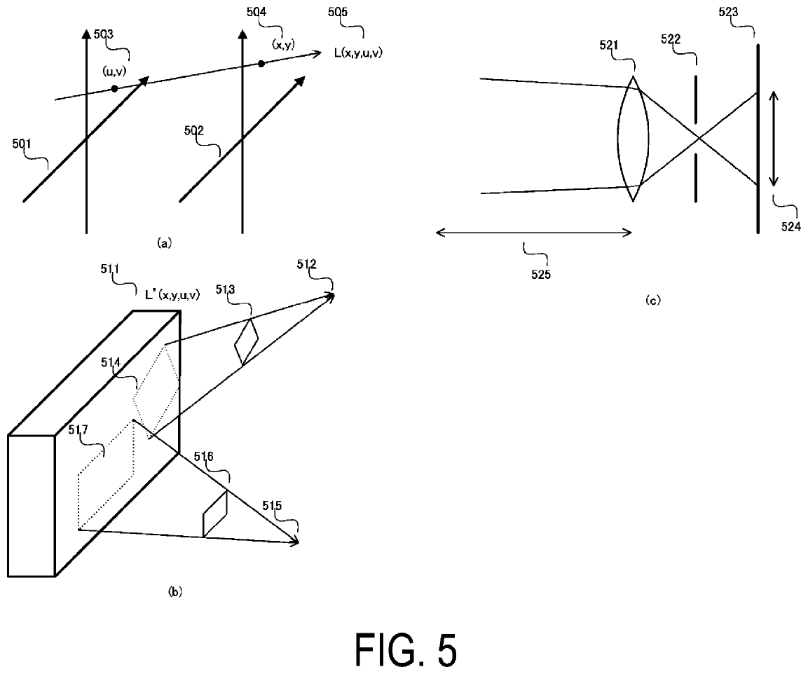

Next, a method in which the video processing apparatus 1-104 and the video processing apparatus 2-105 use multiple pieces of data output from the video display apparatus 101 to generate video data to be used for display by the video display apparatus 102. In the present example, a light field is used to obtain a video of an arbitrary view point. The light field is a collective expression of rays in a certain space and is generally expressed as a set of four or more dimensional vectors. In the present embodiment, a set of four-dimensional vectors, also referred to as Light Slab, is used as light field data. An overview of the light field data used in the present embodiment will be described using HG. 5. As illustrated in FIG. 5(a), the light field data used in the present example expresses a ray passing from a certain point (u, v) 503 on a plane 1-501 toward a certain point (x, y) 504 on a plane 2-502, the planes being in parallel, as a four-dimensional vector L(x, y, u, v) 505. It is only required that u, v, x, y exist in a range required for subsequent calculations or more. An aggregation of Ls obtained for x, y, u, v in the range necessary subsequently is expressed as L′(x, y, u, v). Using this L′ allows a video of an arbitrary view point passing through L′ to be obtained at an arbitrary angle of view. Overview of this is illustrated in FIG. 5(b). 511 denotes the light field data L′(x, y, u, v), and a video of an angle of view 513 viewed from a certain view point 512 is expressed as a set of rays in a direction of the view point 512 from (x, y) in a region 514 on L′. Similarly, a video of a certain angle of view 516 viewed from another view point 515 is expressed as a set of rays in the view 515 direction from a region 517 (x, y) on L′.

Calculations are also possible for a video of the light field data L′ captured by a video camera for which a virtual lens, diaphragm, and imaging element are configured in a similar manner. An example will be described with reference to FIG. 5(c). It is assumed that a lens 521, a diaphragm 522, and an imaging element 523 are included as components of a video camera, and information on a length 525 from a front principal point of the lens 512 to the light field data L′, position (x, y) (not illustrated) of the light field data L′ on an extension of the optical axis of the lens 512, and an angular relationship between the optical axis of the lens 512 and a vertical direction of the light field data L′ is configured. A possible range 524 for capturing is configured in the imaging element 523. The set of rays coming from the light field L′ to enter the possible range 524 for capturing can be calculated, and this calculation is possible by using configurations of the diaphragm 522 and the lens 521 and a configuration of a positional relationship between the lens 512 and the light field data L′ in a so-called ray tracing technique.

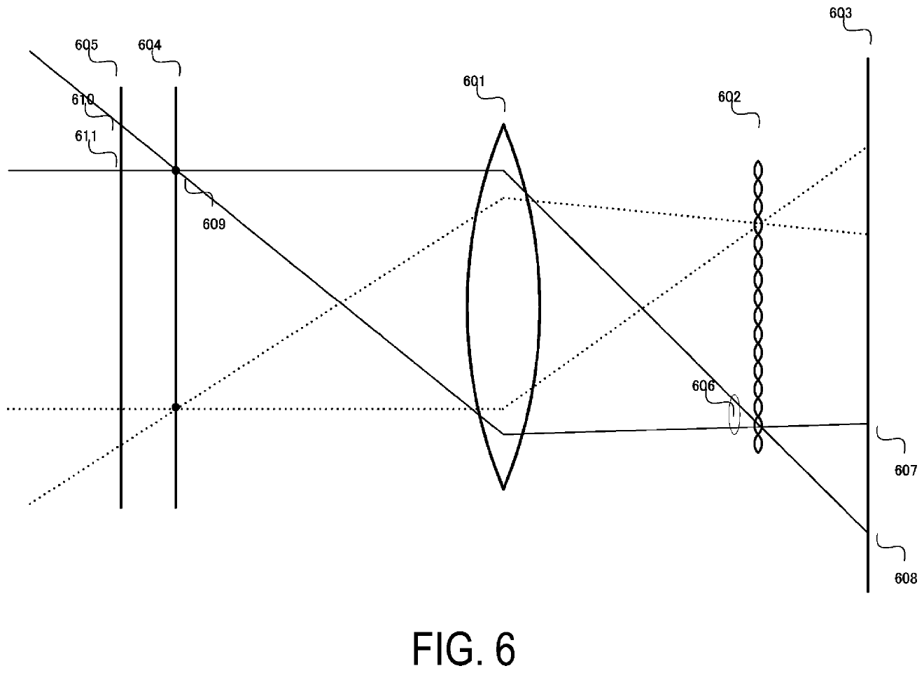

The light field data L′ is a set of data coming to various locations from various directions, and an apparatus called a light field camera is typically used to obtain light field data through capturing. While various types of light field camera have already been proposed, an overview of a type using a microlens array will be described using FIG. 6 as an example. The light field camera includes a primary lens 601, a microlens array 602, and an imaging element 603. The specification of the primary lens 601, the positional relationship of the primary lens 601, the microlens array 602, and the imaging element 603, and the resolutions of the microlens array 602 and the imaging element 603 are assumed to be predetermined.

Rays 606 that pass through the primary lens 601 and pass through a particular lens of the microlens array 602 reach particular positions of the imaging element 603. The positions are determined depending on the specification of the primary lens 601 and the positional relationship of the primary lens 601, the microlens array 602, and the imaging element 603. Assuming a condition where a point 609 on a plane 604 brings rays to focus on the microlens array 602 for simplicity, a ray passing through a point 610 on another plane 605 and then the point 609 on the plane 604 passes through the primary lens 601 and the microlens array 602 to reach a point 607 on the imaging element 603. A ray passing through a point 611 on the plane 605 and then the point 609 on the plane 604 passes through the primary lens 601, and the microlens array 602 to reach a point 608 on the imaging element 603. This means that a ray reaching a point p₁(x₁, y₁) on the imaging element 601 can be expressed by using the light field data L′ including the plane 604 and the plane 605, as follows.

p₁(x1,y1)=F₁·L′(x,y,u,v) (Equation 1)

F₁ is a matrix determined by the specifications of the primary lens 601, the microlens array 602, and the imaging element 603, and the positional relationship of the primary lens 601, the microlens array 602, and the imaging element 603. This means that, using such a light field camera, it is possible to generate light field data in a capturing range in the imaging element 603.

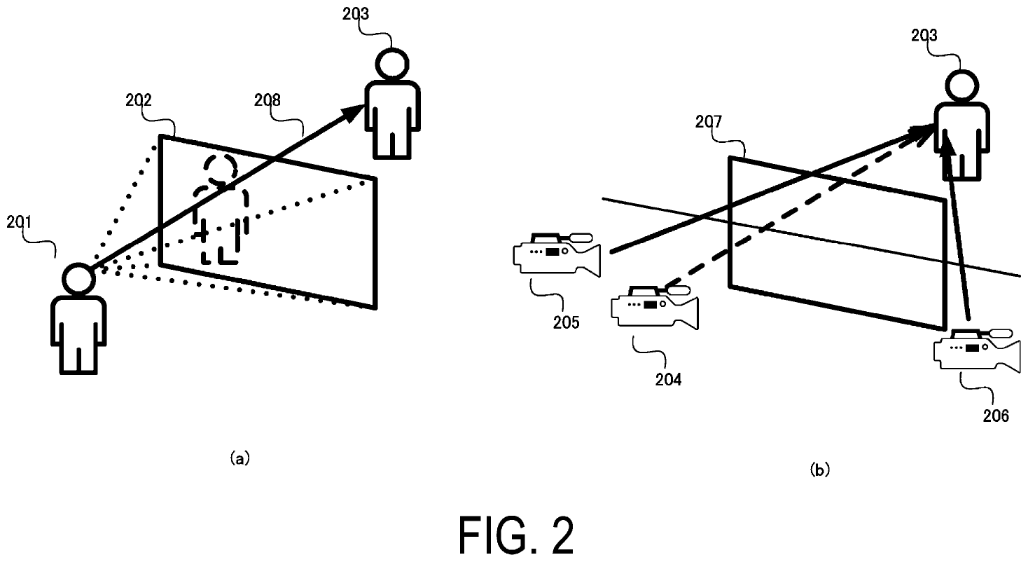

The video camera units 303 to 310 included in the video display apparatuses 101 and 102 used in the present embodiment are not capable of capturing videos of such an angle of view that users illustrated in FIG. 2 directly face each other. However, data obtained through capturing by each of the video camera units 303 to 310 corresponds to part of light field data or data approximately equivalent to part of light field data. This is because, as long as the video camera units 303 to 310 can be installed near the light field camera, it is possible to perform capturing in a ray direction close to a ray direction obtained by the light field camera. The video processing apparatus 1-104 generates light field data to be used to generate an arbitrary view point video, from video information of the part of the light field data. In the present embodiment, non-linear interpolation is performed using a neural network for interpolation of the light field data. In the neural network, the light field data output from the light field camera is learned as supervised data in advance.

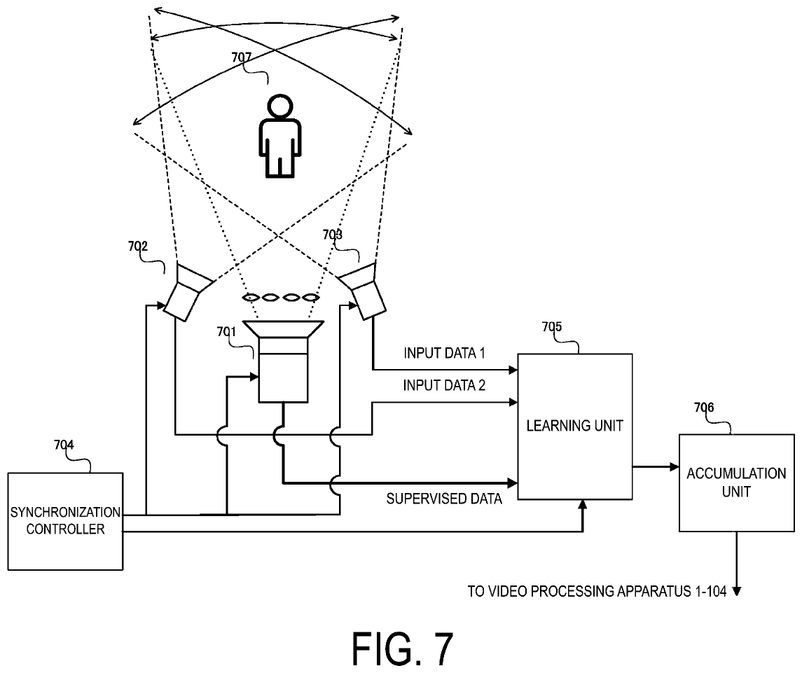

An example of a configuration of equipment used during learning of a neural network is illustrated in FIG. 7. 701 denotes a light field camera, and 702 and 703 denote video camera units. The video camera units 702 and 703 are blocks corresponding to the video camera units 303 to 310 in FIG. 3. While eight video camera units are illustrated in FIG. 3, only the two video camera units 702 and 703 are illustrated in FIG. 7 with other six video camera units being omitted. The video camera units omitted here are assumed to perform similar processing to that of the video camera units 702 and 703. Note that, although the number of video camera units installed on each of the video display apparatuses 102 and 103 and the number of video cameras used during learning are the same in the present embodiment, no limitation is intended, and the number of the cameras included in a video display apparatus and the number of video cameras used during learning may be different from each other. Each of the light field camera 701 and the video camera units 702 and 703 is configured so that an object 702 located at a front position or therearound of the video display apparatus is included in a capturing range of the camera. 704 is a synchronization controller and is configured to synchronize the shutters of the light field camera 701 and the video camera units 702 and 703. A learning unit 705 advances optimization of weighting factors of a model of a neural network by machine learning while changing the object and the position of the object. The neural network used here is assumed to use the videos from the video camera units 702 and 703 as inputs and output light field data. The optimization of the weighting factors is advanced with the use of an output from the light field camera 701 as supervised data so that the output from the neural network and the output from the light field camera 701 would be the same. Although the structure of the neural network is not particularly limited, a Convolutional Neural Network (CNN), which is considered to be suitable for interpolation processing of an image may be used as an example. In a case of calculating light field data by using video outputs at multiple times, specifically, not only video outputs from the video camera units 702 and 703 corresponding to target light field data of a certain time but also video outputs from the video camera units 702 and 703 before and after the certain time, Recurrent Neural Network (RNN) may be used as the structure of the neural network.

Because the size of the light field data, which is an output from the neural network, is large in comparison with inputs to the neural network, in other words, outputs from the video camera units 702 and 703, learning in the neural network may not progress. As a countermeasure to such a situation, restriction may be imposed on the light field data output from the neural network. As a result, the size of the light field data can be reduced, and the learning efficiency in the neural network can be increased. Various methods are conceivable for this restriction, and any method may be used as long as restriction can be imposed on the positions and directions of rays included in a light field as a result. As an example, any of methods such as restricting the position, the optical axis, and the angle of view of a virtual video camera used in generating an arbitrary view point video that is generated using the light field, or restricting the resolution and color depth of an arbitrary view point video to be generated. Some conditions may be configured for signals to be input to the neural network, in other words, outputs from the video camera units 702 and 703 to increase the learning efficiency of the neural network. As an example, restriction may be imposed on arrangement conditions for the light field camera 701 and the video camera units 702 and 703 and the configurations of the video camera units to be used for supervised data. In other words, restriction may be imposed on the number of video cameras used as the video camera units, the arrangement condition configured for each video camera (such as a relative position from the center of the video display unit of each of the video display apparatuses 101 and 102, a relative position from the arrangement position of each of the video display apparatuses 101 and 102, and the inclination of the optical axis with respect to a vertical direction of the video display unit), a lens configuration (such as a focal length and the amount of diaphragm) of each video camera, and the like. As a restriction method, possible values that can be taken for each of the number of video cameras used as the video camera units, the position at which each video camera can be arranged, the direction in which the optical axis can be configured, the focal length that can be configured, and a diaphragm configuration that can be configured may be determined in advance, and only any of the values may be used. Combinations of possible values may be restricted for at least two parameters among the number of video cameras used as the video camera units, the position at which each video camera can be arranged, the direction in which the optical axis can be configured, the focal length that can be configured, and the diaphragm configuration that can be configured. At least one of these parameters may be associated with the size of the video display unit included in each of the video display apparatuses 101 and 102. In this case, possible values for the size of the video display unit may also be determined in advance.

Note that, in a case that these parameters are handled by the video processing apparatus 1-104 and it is indicated that either the camera capability information or the camera arrangement information obtained from the video display apparatus 101 corresponds to multiple configurations, information indicating a configuration to be used may be transmitted to the video display apparatus 101 to indicate the configuration to be used by the video display apparatus 101. In a case that each of the camera capability information, the camera arrangement information, and the display capability information may take multiple values, combinations of values possible to be processed by the neural network may be restricted in advance, and information indicating that some combinations are not possible except for the combinations possible to be processed may be transmitted to the video display apparatus 101. In a case that there is a combination possible for approximation, the combination for approximation may be used instead of indicated combinations. The use of the combination for approximation may be notified.

After the advancement of the learning in the neural network, the learning unit 705 transmits the weights of the neural network to an accumulation unit 706 to accumulate a learning result. At this time, a learning result may be accumulated for each of or each combination of the values such as the number of video cameras used as the video camera units, the position at which each video camera can be arranged, the direction in which the optical axis can be configured, the focal length that can be configured, and the diaphragm configuration that can be configured. The learned weights thus accumulated are transmitted to the video processing apparatus 1-104. The means for transmitting the weights to the video processing apparatus 1-104 is not particularly limited, and the weights may be transmitted using some kind of network or may be transmitted using a physical portable recording medium. The system including the learning unit 705 illustrated in FIG. 7 may or may not be connected to the network 103.

The video processing apparatus 1-104 includes a neural network similar to the neural network used by the learning unit 705, and uses the weights obtained from the accumulation unit 706 to generate light field data from at least one of the display capability information, the camera capability information, and the camera arrangement information transmitted from the video display apparatus 101 and video information obtained through capturing and transmitted from the video display apparatus 101. In a case that the weights obtained from the accumulation unit 706 change based on at least one of the display capability information, the camera capability information, and the camera arrangement information transmitted from the video display apparatus 101, light field data is generated by using the weights corresponding to the parameter on which the change is based. In a case that the video information obtained through capturing and transmitted from the video display apparatus 101 is of multiplexed videos captured by multiple video camera units, demultiplexing processing is performed, and signals output from video camera units having a similar arrangement as video camera arrangement used during learning in the neural network are input to the neural network. In a case that voice data is multiplexed on a signal transmitted from the video display apparatus 101, demultiplexing may be performed on the signal including the voice data at the time of demultiplexing, and signals other than the video data including the voice data may be transmitted to the video processing apparatus 2-105. Control information other than the video data and the voice data, for example, control information such as the display capability information, the camera capability information, and the camera arrangement information, may be transmitted to the video processing apparatus 2-105. In a case that the video information obtained through capturing and transmitted from the video display apparatus 101 is video-coded, complex processing is performed, and a signal obtained as a result of the decoding is input to the neural network.

The light field data generated by the video processing apparatus 1-104 is input to the video processing apparatus 2-105. The video processing apparatus 2-105 generates video data of an arbitrary view point in the manner illustrated in FIG. 5. At this time, a virtual video camera configured with a virtual lens, diaphragm, and imaging element may be used to generate the video of an arbitrary view point. The arbitrary view point and the virtual video camera may be configured by the video display apparatus 102, or may be configured by the video processing apparatus 1-104, based on various data transmitted from the video display apparatus 102. In a case that the video display apparatus 102 configures the arbitrary view point and the virtual video camera, the position at which the user is located may be estimated by using a video camera included in the video display apparatus 102, the arbitrary view point may be configured on an extension of a line linking the estimated position of the user and the center or therearound of the video display unit 302 included in the video display apparatus 102, and the virtual video camera may be configured based on the size of the video display unit 302 included in the video display apparatus 102. As an example of the estimation of the position of the user, a parallax map may be created from each piece of video information obtained from the multiple video camera units included in the video display apparatus 102, a region near the video display apparatus 102 of the parallax map may be estimated as the user, and the position of the user may be estimated from the parallax of the region. The video display apparatus 102 may include a sensor other than the video camera, for example, a pattern irradiation type depth sensor to estimate an object closer than the background as a user and configure the arbitrary view point by using the position of the object. In a case that the video processing apparatus 1-104 configures the arbitrary view point and the virtual video camera, based on the various data transmitted from the video display apparatus 102, a parallax map may be created by using video information obtained through capturing by each of the video camera units 303 to 310 included in the video display apparatus 102 and transmitted from the video display apparatus 102 similarly, the region near the video display apparatus 102 in the parallax map may be estimated as the user, and the position of the user may be estimated from the parallax of the region. The size of the video display apparatus 102 included in the display capability information transmitted from the video display apparatus 102 may be used to configure the virtual video camera.

The video processing apparatus 2-105 generates video data of the arbitrary view point by using the configured arbitrary view point and also using, in a case that the virtual video camera is configured, the configuration of the virtual video camera. The resolution of the video data of the arbitrary view point generated at this time may be configured based on the display capability information of the video display apparatus 102. The resolution of the video data of the arbitrary view point may be configured by configuring sampling intervals of the light field data. The generated video data of the arbitrary view point is video-coded, and in a case that voice data is input from the video processing apparatus 1-104, the coded video data and the voice data are multiplexed and transmitted to the video display apparatus 102.

The video display apparatus 102 receives the video data of the arbitrary view point and the voice data thus multiplexed, the received data passes through the network interface unit 428 and the communication controller 422, the demultiplexing unit 423 separates the coded video data and the coded voice data. The coded video data is decoded by the video decoder 424, and the resultant data is displayed by the video display unit 425. The coded voice data is decoded by the voice decoder 426, and the resultant data is output by the voice output unit 427 as voice.

With the above-described operation, by generating video data of an arbitrary view point by using video data obtained through capturing by each of the multiple video camera units 303 to 310 arranged outside the video display unit 302 of each of the video display apparatuses 101 and 102, it is possible to generate video data of an arbitrary view point with users directly facing while sandwiching the video display apparatuses 101 and 102 and to hence perform video communication with good immersive feeling.

Note that equivalent configurations may be made for the multiple video camera units 303 to 310 for capturing, but different configurations may be made for the multiple video camera units 303 to 310 to generate light field data. This is because, in a case that the performance of each of the multiple video camera units 303 to 310 included in each of the video display apparatuses 101 and 102 is lower than the performance of the light field camera 701 used during learning, capturing videos by changing the configurations of the multiple video camera units 303 to 310 allows generation of light field data close to the performance of the light field camera 701 in some cases. As an example, in a case that the color depth of the data obtained through capturing by each of the multiple video camera units 303 to 310 included in each of the video display apparatuses 101 and 102 is lower than that of the light field camera 701, the multiple video camera units 303 to 310 may be divided into multiple groups, and the groups may be changed in diaphragm configuration to configure a group having a diaphragm configuration suitable for a scene with high illuminance and a group having a diaphragm configuration suitable for a scene with low illuminance. For example, video capturing may be performed with the video camera units 303, 305, 307, and 309 having a narrow diaphragm configuration to use the configuration suitable for a scene with high illuminance and the video camera units 304, 306, 308, and 310 having an open diaphragm configuration to use the configuration suitable for a scene with low illuminance. In a case of employing such configurations, learning by the learning unit 705 is performed by using similar configurations as those of the video camera units 303 to 310 described above with respect to the diaphragm configuration and arrangement of each of the video camera units (702, 703, and the camera units omitted in illustration) to use during learning by the neural network using the light field camera 701. With learning being advanced in this state, light field data output by the neural network results in that close to the performance of the light field camera 701. The video display apparatus 101 may be configured to make the configurations of the video camera units 303 to 310 by the video processing apparatus 1-104, and the video processing apparatus 1-104 may use camera capability information and camera arrangement information that are received from the video display apparatus 101 to make the configurations of the video camera units 303 to 310 of the video display apparatus 101.

By making different configurations for the respective video camera units 303 to 310 as described above, it is possible to increase the quality of light field data generated by the video processing apparatus 1-104 and improve the quality of video data of an arbitrary view point generated by the video processing apparatus 2-105, to thereby be able to perform video communication with good immersive feeling. Different configurations for the respective video camera units 303 to 310 may be made for other parameters such as focal length, and color depth and the resolution of video data to be output, in addition to the diaphragm configuration.

### Second Embodiment

The present embodiment generates video data of an arbitrary view point by using surface data, instead of generating video data of an arbitrary view point by using light field data in the first embodiment.

Each of video display apparatuses 101 and 102 has a configuration equivalent to that in the first embodiment. The processing of the video processing apparatus 1 is changed, and a parallax map is created using video data obtained through capturing by multiple video camera units 303 to 310 of the video display apparatus 101 to generate a 3D surface model, based on the parallax maps. Texture data is generated based on the video data obtained though the capturing by each of the multiple video camera units 303 to 310 on the 3D surface model, and the 3D surface model, the texture data, and voice data transmitted from the video display apparatus 101 are transmitted to the video processing apparatus 2. The processing of the video processing apparatus 2 is also changed, video data of an arbitrary view point is generated as 3DCG video from the 3D surface model and the texture data received from the video processing apparatus 1 and information of configured virtual cameras to be coded, and voice data transmitted from the video display apparatus 101 is multiplexed on the 3DCG video to transmit the multiplexed data to the video display apparatus 102.

With the above-described operation, by generating video data of an arbitrary view point by using video data obtained through capturing by each of the multiple video camera units 303 to 310 arranged outside the video display unit 302 of each of the video display apparatuses 101 and 102, it is possible to generate video data of an arbitrary view point with users directly facing while sandwiching the video display apparatuses 101 and 102 and to hence perform video communication with good immersive feeling.

### Common to All Embodiments

A program running on an apparatus according to the present invention may serve as a program that controls a Central Processing Unit (CPU) and the like to cause a computer to operate in such a manner as to realize the functions of the above-described embodiments according to the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiments according to the present invention may be recorded in a computer-readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining the program for a short time, or any other computer readable recording medium.

Furthermore, each functional block or various characteristics of the apparatuses used in the above-described embodiments may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, one or more aspects of the present invention can use a new integrated circuit based on the technology.

Note that the invention of the present patent application is not limited to the above-described embodiments. In the embodiments, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

The present invention is applicable to a video display apparatus and a video processing apparatus.

1. A video display apparatus for communicating with one or more video processing apparatuses, the video display apparatus comprising:
a video display unit;
multiple video camera units;
a synchronization controller; and
a controller, wherein
each of the multiple video camera units is installed outside the video display unit,
the synchronization controller synchronizes shutters of the multiple video camera units,
the controller transmits, to any one of the one or more video processing apparatuses, camera capability information indicating capability of each of the multiple video camera units, camera arrangement information indicating an arrangement condition of the multiple video camera units, display capability information indicating video display capability of the video display unit, and video information obtained through capturing by each of the multiple video camera units, and
video information transmitted from any one of the one or more video processing apparatuses is received and the video information is displayed on the video display unit.

2. The video display apparatus according to claim 1, wherein
the camera arrangement information includes location information of each of the multiple video camera units relative to a prescribed point being used as a reference in the video display unit included in the video display apparatus and includes information on an optical axis of each of the multiple video camera units with respect to a display surface of the video display unit being used as a reference.

3. The video display apparatus according to claim 1, wherein
the camera capability information includes information on a focal length and a diaphragm of a lens configuration used by each of the multiple video camera units.

4. The video display apparatus according to claim 1, wherein
the display capability information includes at least one of information on a size of the video display unit included in the video display apparatus, information on a possible resolution displayable by the video display unit, information on a possible color depth displayable by the video display apparatus, and information on arrangement of the video display unit.

5. The video display apparatus according to claim 1, wherein
the controller receives configuration information of each of the video camera units from any one of the one or more video processing apparatuses and configures each of the multiple video camera units in accordance with the configuration information.

6. The video display apparatus according to claim 1, wherein
in a case that multiple values are configurable in each of at least two of the display capability information, the camera capability information, and the camera arrangement information, combinations of values of the display capability information, the camera capability information, and the camera arrangement information to be transmitted to the video processing apparatus are partially restricted.

7. A video processing apparatus for communicating with multiple video display apparatuses including a first video display apparatus and a second video display apparatus, wherein
the video processing apparatus is configured to
receive, from the first video display apparatus, camera capability information indicating capability of multiple video camera units, camera arrangement information indicating an arrangement condition of the multiple video camera units, display capability information indicating video display capability of the video display apparatus, and video information obtained through capturing by each of the multiple video camera units,
generate an arbitrary view point video from the video information thus received, and
transmit the arbitrary view point video to the second video display apparatus.

8. The video processing apparatus according to claim 7, wherein
in a case that multiple values are configurable in each of at least two of the display capability information, the camera capability information, and the camera arrangement information, a combination of the display capability information, the camera capability information, and the camera arrangement information is restricted.
